(19) United States
(12) Patent Application Publication
(10) Pub. No.: US 2025/0353249 A1
(43) Pub. Date: Nov. 20, 2025

(54) WIRE TRAP AND METHOD OF FORMING A WIRE TRAP

(71) Applicant: Q5D Technologies Limited, Portishead, Bristol (GB)

(72) Inventor: Christopher Thomas ELSWORTHY, Portishead, Bristol (GB)

(73) Assignee: Q5D Technologies Limited, Portishead, Bristol (GB)

(21) Appl. No.: 18/871,749

(22) PCT Filed: Jun. 2, 2023
(86) PCT No.: PCT/GB2023/051459

§ 371 Date: Dec. 4, 2024

(30) Foreign Application Priority Data
Jun. 6, 2022 (GB) 2208245.7

(51) Int. Cl. B29C 64/118; B29C 64/379; B29L 31/34; B33Y 10/00; B33Y 30/00; B33Y 40/00; B33Y 80/00

(52) U.S. Cl. CPC B29C 64/118; B29C 64/379; B33Y 10/00; B33Y 30/00; B33Y 40/00; B33Y 80/00; B29L 2031/3481

(57) ABSTRACT

A method of forming a wire trap on a surface of a product for holding a wire is provided. The method comprises forming a wire trap by deposition onto the surface of the product such that the wire trap defines a channel for holding the wire. The channel comprises a channel opening and channel walls defining a channel width that varies as a function of channel depth from the channel opening to a channel base of the channel, the channel opening having an opening width that is smaller than a maximum channel width such that, when received in the wire trap, a wire having a diameter larger than the opening width can be held in the channel by an interference fit. A product comprising a wire trap is also provided.

The invention relates to a method of forming a wire trap on a product, to a product comprising a wire trap, and to a method of positioning a wire on a product.

Wiring harnesses are part of almost all modern products, giving them function, and carrying both information and power. Currently harnesses are largely made by hand. Although there are now sophisticated robotics that can cut wire to length and add crimp terminations, the lay-up of the harness is almost exclusively done on a pin-board by skilled workers, as is the installation of the harness in the product.

A typical process involves a series of steps. First, the wires are cut, stripped and crimped. Next, a 1:1 scale pin-board is used to organize wires into bundles which are held together with ties or sleeves. Then termination connectors (or plugs) are added. The wires or wire bundles are labeled and there is a quality control check. The harness is then packaged and shipped to the OEM. At the OEM the harness is installed into the product. Often further stand-offs and mounts and ties are needed to hold the wires in place. This is a complex, labour intensive and costly process that can result in manufacturing errors that require expensive product recalls.

A large fraction of the weight of a harness is made up of the ties, sleeves, stand-off and mounts. Even the choice of wire gauge is often determined by a need for the wire to be sufficiently robust to survive the rigors of the manual manufacturing process, which has weight implications for aerospace and automotive products.

Conventional wiring harnesses are also associated with a number of failure modes. For example, in high vibration environments wires or cables can abrade against other wires in the harness or against other parts of the structure of the product. This damages insulation and can cause failures or even fires. Additionally, the polymers that are used in the insulation of the wire can break down over time and become brittle. This can be greatly accelerated in environments where they are exposed to UV, humidity, or other fluids such as cleaning fluids or even fuels. Once brittle the insulation can crack under strain, vibration or even during maintenance. Another key failure mode is caused by repeated vibration or strain on the terminations. They can open up the joint between the wire and the termination allowing for corrosion, heating and ultimately failure.

It is an object of this invention to alleviate one or more of these challenges.

According to a first aspect of the invention there is provided a method of forming a wire trap on a surface of a product for holding a wire, the method comprising: forming a wire trap by deposition onto the surface of the product such that the wire trap defines a channel for holding the wire, wherein the channel comprises a channel opening and channel walls defining a channel width that varies as a function of channel depth from the channel opening to a channel base of the channel, the channel opening having an opening width that is smaller than a maximum channel width such that, when received in the wire trap, a wire having a diameter larger than the opening width can be held in the channel by an interference fit.

Depositing a wire trap directly onto a surface avoids the need for connecting means such as stand-offs. Further, the wire is embedded into a dedicated channel, where the wire is protected from chaffing against other wires or components. As a result, smaller gauges of wire can be used without risking failure. This can save significant weight. Additionally, because a wire in the wire trap shares the stresses and strains of the surface it is mounted on, modern finite element analysis can be used in the design to ensure that terminations are not over strained. Moreover, the present method provides a simple and readily automated process for forming a wire trap. This allows a product to be automatically functionalised by providing tailored wire traps for the product, without the time and expense associated with conventional manual approaches. Not only can the wire trap itself be quickly and automatically deposited, but also a wire can be readily automatically positioned in the wire trap. The form of the wire trap means a wire can be simply pressed into the trap through the channel opening, where it is held by the interference fit without any further manipulation of the trap being necessary. This process can be readily performed by a robotic tool. Thus the method enables fully automated processes for functionalising a product with one or more wires.

In some embodiments, forming the wire trap on the surface comprises forming the wire trap using an additive manufacturing technique such as a fused filament fabrication (FFF) technique. Additive manufacturing techniques are ideally suited to the present method, providing a fast and efficient process of depositing material onto a surface to form the channel walls.

In particular embodiments, forming the wire trap comprises depositing, using a fused filament fabrication technique, a plurality of layers of filaments on the surface of the product to form the wire trap.

The present inventors have realised that the natural shape of FFF filaments is ideally suited to forming wire traps according to the present method. Filaments have a lozenge shape, with a width that varies with the height of the filament. Therefore the filaments themselves can provide the varying channel widths of the wire trap, without requiring additional components or processing. In particular, the channel opening may be formed by an upper layer or upper layers of filaments. In other words, the channel opening may be formed by a minimum spacing between opposing filaments of an upper layer (i.e. between an upper layer filament in a first channel wall and a corresponding opposing filament in a second channel wall). Such embodiments minimise the material required to form the wire trap, thereby minimising the weight of the wire trap, as well as simplifying the manufacturing process.

In some embodiments, the plurality of layers of filaments are deposited such that corresponding filaments of contacting layers are horizontally aligned. Such embodiments provide a simple method for depositing the channel walls, making use of the shape of the filaments to provide the narrower parts of the channel.

Alternatively, filaments of one or more layers of filaments may be horizontally offset with respect to corresponding filaments of other layers. In particular, one or more middle layers may be offset to form a wider part of the channel for receiving the widest part of the wire.

In some embodiments the method further comprises depositing a polymer or adhesive into the channel for securing the wire when received in the channel. This provides a secondary means for holding the wire in the wire trap, in addition to the interference fit, increasing the reliability of the wire trap. Alternatively or additionally, the method may comprise, after positioning a wire in the wire trap, enclosing the channel opening to fix the wire in the trap. Enclosing the channel may additionally provide environmental protection, reducing degradation of the wire.

According to a second aspect of the invention there is provided an automated method of positioning a wire on a surface of a product, the method comprising: forming a wire trap on the surface of the product using the method of any embodiment of the first aspect; and placing, using a robotic tool, a wire into the wire trap.

According to a third aspect of the invention there is provided a computer program comprising instructions which, when executed, cause the computer to perform the method of any embodiment of the first aspect or the second aspect. For example, the computer program may be executable to control a robotic tool to perform the method.

According to a fourth aspect of the invention there is provided a computer readable medium storing the computer program of the third aspect.

According to a fifth aspect of the invention there is provided a robotic apparatus for functionalising a product, the robotic apparatus comprising: a deposition module configured to progressively deposit filaments onto a surface of a product to be functionalised; and a spatial manipulation system configured to allow relative movement between the product and at least a portion of the deposition module; wherein the robotic apparatus is configured to perform the method of any embodiment of the first or second aspects.

According to a sixth aspect of the invention there is provided a product comprising a wire trap for holding a wire, wherein the wire trap is formed by deposition onto a surface of the product, and defines a channel for holding the wire, wherein the channel comprises a channel opening and channel walls defining a channel width that varies as a function of channel depth from the channel opening to a channel base of the channel, the channel opening having an opening width that is smaller than a maximum channel width such that, when received in the wire trap, a wire having a diameter larger than the opening width can be held in the channel by an interference fit.

In some embodiments the product further comprises a wire held in the wire trap. The product may further comprise any of the features of the wire trap discussed in relation to the first aspect.

Embodiments of the invention will now be described, by way of example only, with reference to the accompanying drawings in which corresponding reference symbols indicate corresponding parts, and in which:

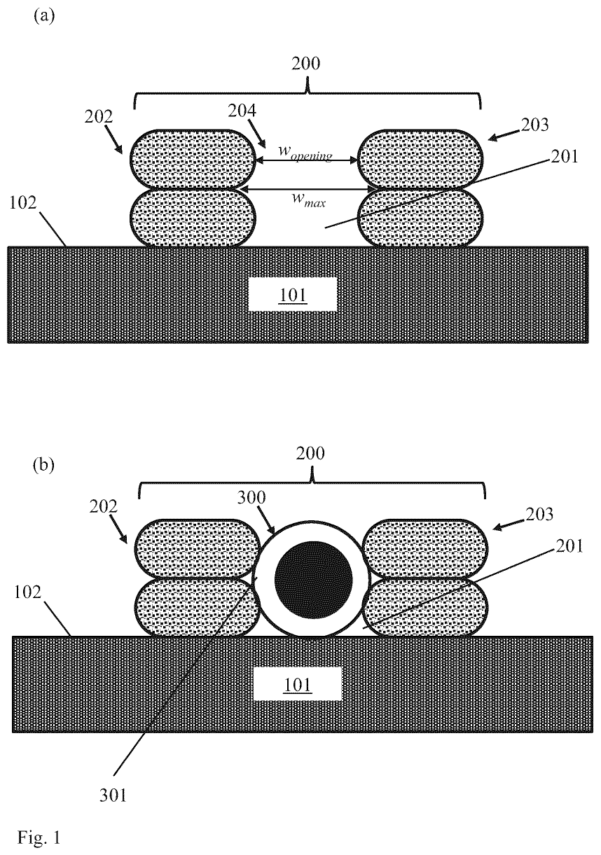

FIG. 1 illustrates an example of a wire trap;

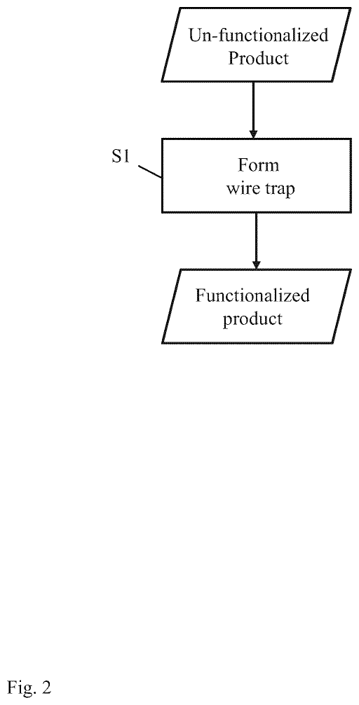

FIG. 2 shows a representation of a method of forming a wire trap;

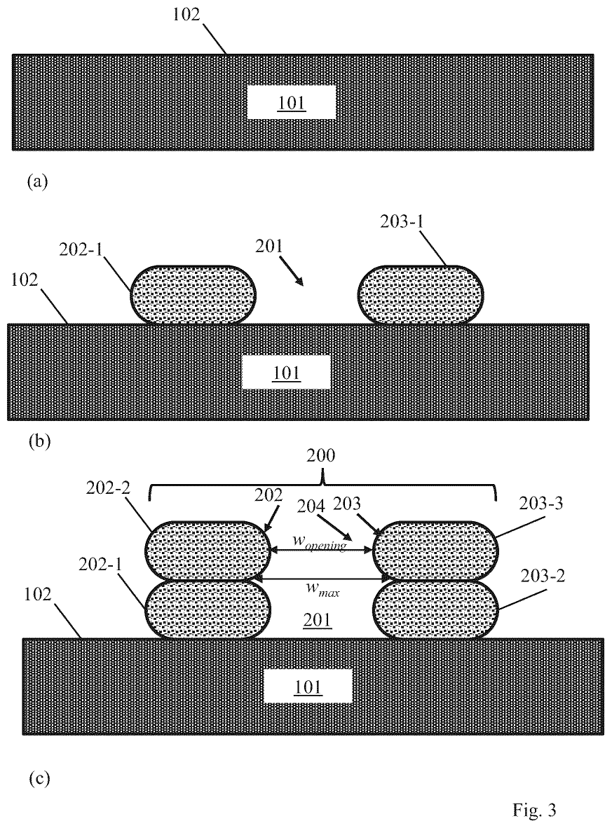

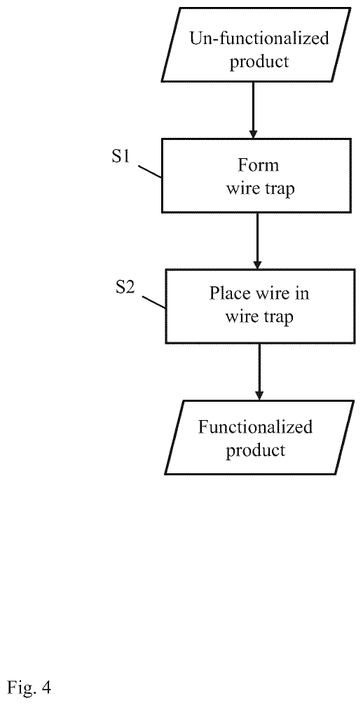

FIG. 3 illustrates an example implementation of the method of FIG. 2;

FIG. 4 shows a representation of a method of forming a wire trap including placing a wire in the wire trap;

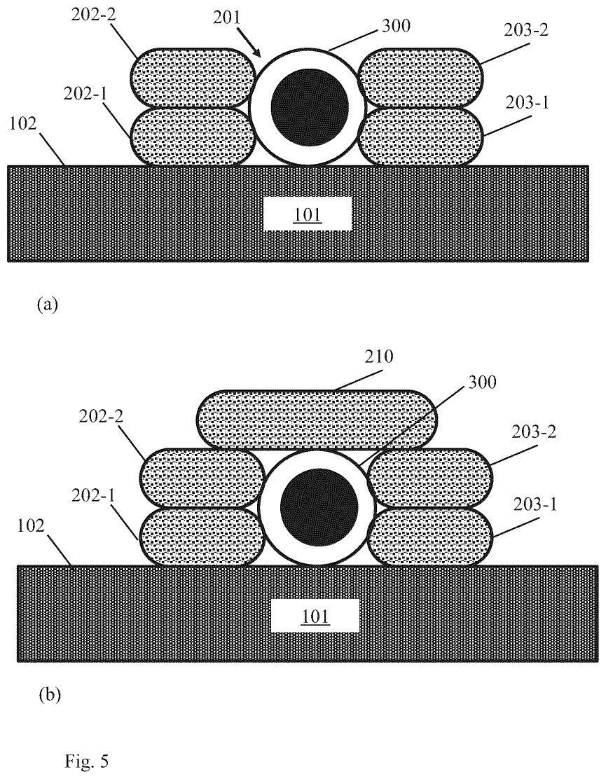

FIG. 5 illustrates an example implementation of the method of FIG. 4;

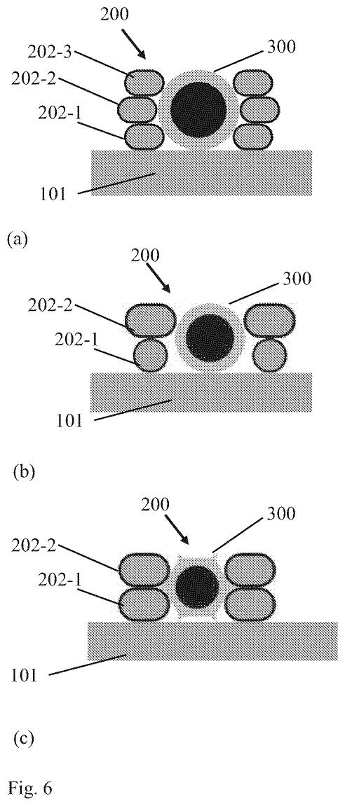

FIG. 6 shows examples of alternative wire traps;

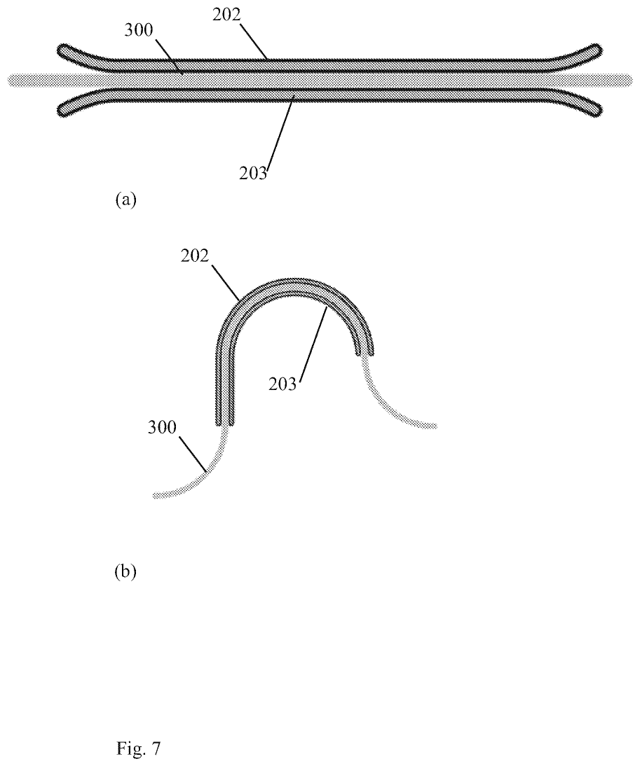

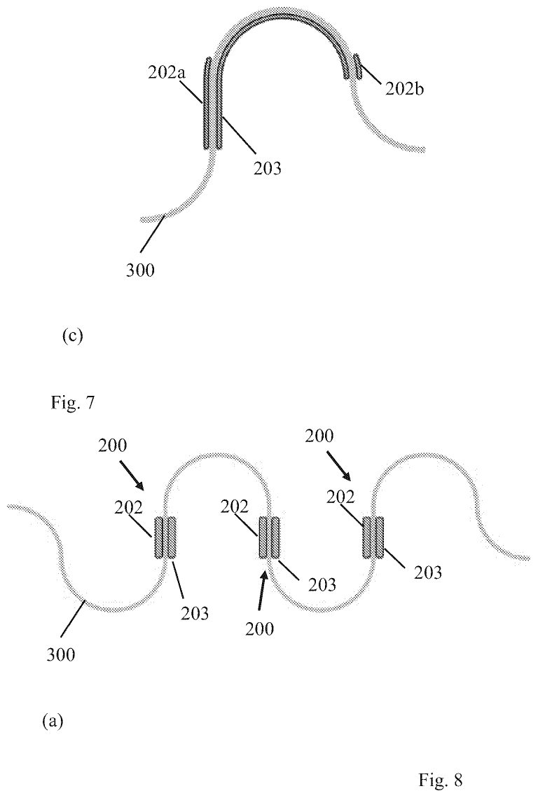

FIG. 7 shows additional features of wire traps;

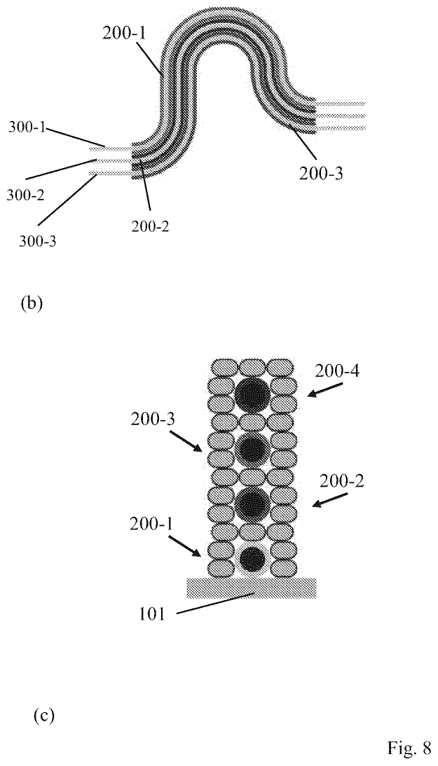

FIG. 8 shows examples in which a plurality of wire traps are formed; and

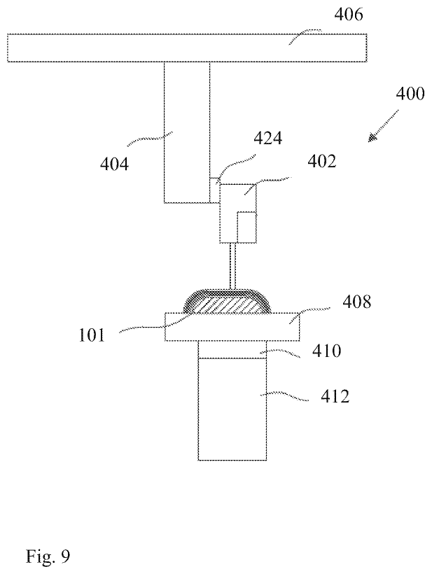

FIG. 9 illustrates a robotic tool for performing the methods of forming a wire trap.

FIG. 1(a) illustrates a product 101 with a wire trap 200 formed on a surface 102 of the product 101. The wire trap 200 is for holding a wire 300, which may be an insulated or uninsulated wire. The wire 300 may be a power and/or data wire or cable. The wire trap 200 comprises a channel 201 defined by a pair of channel walls 202, 203. The walls 202, 203 run longitudinally along the length of the wire trap 200, i.e. along the length of a wire when received in the wire trap 200.

The channel has a channel width w between the channel walls 202, 203 that varies as a function of channel depth. Channel depth is the depth of the channel from a channel opening 204 to the surface 102. The channel opening 204 is defined by an upper portion of the walls 202, 203, and is the opening through which a wire enters the wire trap 200.

The channel opening has an opening width w_{opening}. The opening width w_{opening} is less than a maximum width of the channel, wₘₐₓ. In other words, an upper portion of the channel 201 is narrower than a lower portion of the channel 201.

FIG. 1(b) illustrates the wire trap 200 with a wire 300 received in the wire trap 200. As can be seen, the wire trap 200 is such that when the wire 300 is received in the channel, the channel width w above a widest part 301 of the wire 300 is less than a width of the widest part 301 of the wire 300. Here, the widest part 301 is the widest part of the wire 300 with respect to the width of the channel 103, i.e. in a plane substantially parallel to the surface 102. For wires 300 with a circular cross-section the width of the widest part 301 of the wire 300 is the diameter of the wire 300. As a result, the wire 300 is partially surrounded by upper parts of the channel walls 202, 203. This forms an interference fit, holding the wire 300 in the wire trap 200. In general, walls 202, 203 may conform to a size and shape of a wire 300 for which the wire trap 200 is designed, in order to form an interference fit around multiple parts of the wire 300. In particular, the channel walls 202, 203 may be formed such that when the wire 300 is received within the channel 201, each channel wall 202, 203 remains in constant contact with the wire 300 at one or more points of the wire 300. The channel walls 202, 203 may be formed such that the wire 300 is substantially unable to move within the channel 201, unless sufficient force is applied to pull the wire out through the channel opening 204.

FIG. 2 shows a schematic representation of a method of forming a wire trap on a surface 102 of a product 101 for holding a wire 300. FIG. 3 further illustrates this method for an example wire trap 200. The method may in particular be an automated method performed by a robotic tool. The method may be implemented for example as a computer program comprising instructions which, when executed, cause the computer to perform the method. For example the computer program may be executable by a robotic tool to perform the method. In other examples the method is implemented as a computer readable medium storing such a computer program.

The method starts with an un-functionalized product, which is a product 101 before formation of a wire trap 200. This initial state is shown in FIG. 3(a), where a product 101 with a surface 102 is provided. In the illustrated example the surface 102 is shown as a flat surface, but in other examples the method 100 may be used to form a wire trap on contoured surfaces. The surface 101 may for example be a surface of an existing product or component that has been manufactured using polymer forming techniques such as injection moulding or vacuum forming, or the surface of a fibre-composite part or even a pressed sheet metal component.

The method comprises, at S1, forming a wire trap 200 by deposition onto the surface 102 of the product 101. In the example of the method illustrated in FIG. 3, forming the wire trap 200 on the surface 102 comprises forming the wire trap 200 using an additive manufacturing technique. In particular, the illustrated example uses a fused filament fabrication (FFF) technique. FFF techniques deposit a plurality of filaments of material which fuse to form a solid structure. However it is to be appreciated that any suitable form of deposition, and in particular any suitable additive manufacturing technique, may be used to deposit the wire trap.

As illustrated, in some examples of the method the channel walls 202, 203 are formed by depositing a plurality of layers of material onto the surface of the product to build up the height of the channel walls 202, 203. In particular, in the case of FFF deposition, a plurality of layers of filaments of material may be deposited. This process is illustrated in FIGS. 3(b) and 3(c).

In FIG. 3(b), a first layer of filaments 202-1, 203-1 is deposited on the surface 102. Filaments 202-1 form an initial layer of channel wall 202. Filaments 203-1 form an initial layer of channel wall 203. Filaments 202-1 are separated from filaments 203-1 by a gap, which will form channel 201 into which a wire 300 is received. In the illustrated example only two filaments 202-1, 203-1 are shown, one for each of the channel walls 202, 203. As will be appreciated, further filaments 202-1, 202-2 can deposited in line with the illustrated filaments to form the length of the channel walls 202, 203 (i.e. extending into the plane of the page).

In FIG. 3(c), a second layer of filaments 202-2, 203-2 is deposited on top of the first layer of filaments 202-1, 203-1. Filaments 202-2 form a second layer of the channel wall 202. Filaments 203-2 form a second layer of channel wall 203. The respective groups of filaments 202-1, 202-2 and 203-1, 203-2 each fuse as they cool, forming two separate walls 202, 203 defining the channel 201.

In the illustrated example, the second layer of filaments 202-2, 203-2 define the channel opening 204. The channel opening 204 is the narrowest width between the respective filaments 202-2, 203-2. As discussed above, the channel opening 204 is smaller than a maximum width of the channel. This means that, when received in the channel, the wire 300 is partially enclosed by the upper parts of the channel walls 202, 203, forming an interference fit that retains the wire 300 in the trap. The present inventors have realised that FFF techniques are ideal for providing such an arrangement. The filaments deposited by FFF typically have a lozenge shape, i.e. are wider towards their middle than at their top or bottom. This means that the wider part of the filament can be used to form the narrower channel opening 204, whilst the narrower top/bottom of filaments can be used to provide the wider part of the channel 201. Thus the channel opening 204 may be formed by an upper layer or upper layers of the layers of filaments. For example, the channel opening 204 may be defined by the minimum spacing between an upper layer filament of channel wall 202 and a corresponding (i.e. opposite) upper layer filament of channel wall 203.

In the illustrated example, the walls 202, 203 are formed from two layers of filaments. In such cases, the deposition of filaments may be controlled such that the height of each filament is approximately half the diameter/height of the wire 300 for which the wire trap 200 is intended. Height is the dimension of the filament/wire in the same direction as channel depth. Approximately half means within 10%, or within 5% or within 2% of half the diameter/height of the wire 300.

Further, in the illustrated example the layers of filaments are deposited such that corresponding filaments of contacting layers are approximately horizontally aligned. Thus a filament 202-1 is horizontally aligned with the filament 202-2 above it, and similarly for filaments 203-1, 203-2. This makes the deposition process quicker and easier, as a simple repeating pattern can be used for the depositing process, whilst making use of the shape of the filaments to provide the form of the channel 201 discussed above. Here horizontally aligned means aligned in a direction orthogonal to the channel depth and orthogonal to the longitudinal length of the channel 201. Approximately horizontally aligned means aligned with a tolerance of 10%, 5% or 2% of the width of an individual filament.

In some examples, the method of FIG. 2 may end after deposition of the wire trap 200 in S1. The resulting product 101 with wire trap 200 may be termed a functionalized product.

In other examples, the method of FIG. 2 may further comprise placing a wire 300 into the wire trap 200. In such cases the product may be considered functionalized only after the wire 300 has been placed into the wire trap 200.

FIG. 4 schematically represents a method of positioning a wire on a surface of a product. The method comprises at S1 forming a wire trap on the surface of the product using the method of any preceding claim, using any of the examples of step S1 described above or below. The method then comprises, at step S2, placing a wire into the wire trap. In particular examples, the method of FIG. 4 is an automated method, and either one or both of S1, S2 are performed by a robotic tool. Preferably, both S1 and S2 are performed by the same robotic tool, for example using different robotic heads of the tool. FIG. 5(a) illustrates a wire 300 received in the trap 200 shown in FIG. 3.

Placing the wire 300 in the wire trap 200 in particular comprises applying a downwards force to press the wire 300 into the wire trap 200. The material forming the wire trap 200, or at least the material forming the walls 202, 203 around channel opening 204, has an elasticity such that the wire trap 200 can expand to receive the wire through the channel opening 204. After the wire 300 has been inserted, the walls 202, 203 contract back to partially enclose the wire 300. This elastic property may be provided by appropriate selection of the material used to form the walls 202, 203. For example, the walls 202, 203 may be formed of almost any thermoplastic that can be used in additive FFF additive manufacturing, such as Acrylonitrile butadiene styrene (ABS), polyamide plastics such as nylon, polylactic acid (PLA), Polyethylene terephthalate (PET) or even high performance polymers such as polyether ether ketone (PEEK), polyether ether ketone ketone (PEKK) or polyetherimides (PEI).

Although the form of the wire trap 200 itself secures the wire 300 by the interference fit, some examples use additional securing means to ensure the wire 300 stays in the trap 200. Such examples might be used in applications where it is particularly important that the wire trap 200 does not fail, such as aerospace applications. Thus in some examples, the method of FIG. 2 or FIG. 4 further comprises depositing a polymer or adhesive or into the channel 201 for securing the wire 300 when received in the channel 201. Alternatively or additionally, some examples further comprise, after positioning a wire 300 in the wire trap 200, enclosing the channel opening 204.

FIG. 5(b) illustrates such an example. In this case, after the wire 300 has been placed in the channel 201, a further filament 210 is deposited to cover the wire trap 200. The further filament contacts the upper layer of the two channel walls 202, 203, fully enclosing the channel 201 and wire 300. In general, any means for enclosing or partially enclosing the channel 201 may be used to provide the additional securing means.

So far the methods of the present disclosure have been described with reference to the two-layer wire trap 200 of FIGS. 3 and 5. However, there are a number of different forms of wire trap 200 that can be used to provide the interference fit. FIG. 6 illustrates particular examples of alternative forms of wire trap 200.

FIG. 6(a) illustrates an example of a wire trap 200 comprising three layers of filaments. For clarity, only the individual filament layers of channel wall 202 have been labelled in FIG. 6. In this example, a third layer of filaments 202-3, 203-3 is deposited on top of the second layer of filaments 202-2, 202-3. The filaments are deposited to form a channel 201 suitable for receiving a wire 300, and for partially enclosing the wire 300 in the channel 201 by virtue of the narrower channel opening 204. In the illustrated example, the gap between filaments 202-3 and 203-2 of the third layer forms the channel opening 204. The second layer of filaments 202-2, 203-2 is horizontally offset with respect the first layer of filaments 202-1, 203-1 and the third layer of filaments 202-3, 203-3. The offset is such that the width between the filaments 202-2 and 203-2 is greater than the width of the channel opening 204, allowing the maximum width of the wire to be received within the channel 201.

In general examples, the channel walls 202, 203 may be formed of any number of layers, including one layer. The walls are formed so as to conform (at least in part) to the shape and size of a wire for which the wire trap 200 is intended, and to partially enclose the channel 201 when the wire 300 is in position so as to retain the wire 300 in the wire trap 200. For example, one or more of the layers of filaments (or generally parts of the walls 202, 203) may be horizontally offset with respect to other layers/parts to provide the narrower channel opening 204 discussed above. In general any or all layers of filaments located above the widest part 301 of the wire 300 when received in the trap 200 may be formed to define a narrower channel width than layers at or below the widest part 301.

In some examples, the filaments of one layer may have a different size and/or shape to filaments of another layer of filaments. FIG. 6(b) illustrates an alternative example of a two-layer wire trap 200. In this example, the first layer filaments 202-1, 203-1 are narrower than the second layer filaments 202-2, 203-2. The layers are approximately horizontally aligned with each other. For example, filament 202-1 is approximately horizontally aligned with filament 202-2. The narrower first layer filaments 202-1, 203-1 define the maximum channel width wₘₐₓ, whilst the wider second layer filaments 202-2, 203-2 define the narrower channel opening 204.

So far the outer surface of the wire 300 has been shown as circular. However, the wire 300 may in general have any cross-sectional shape. FIG. 6(c) shows an example of a wire trap 200 that is similar to wire trap 200 of FIGS. 3 and 5. In this case, however, a non-circular wire 300 is placed in the wire trap. The widest part of the channel 201 receives the widest part of the wire 300 (with respect to the horizontal direction). As with the circular wire examples, the narrower channel opening 204 partially encloses the wire 300, so that wire 300 is held in the wire trap 200 by an interference fit.

FIGS. 7(a)-(c) show examples of further features that can be incorporated into any of the wire traps 200 discussed above. Each of FIGS. 7(a)-(c) illustrate a bird's eye view, looking down on the wire trap 200 from above.

FIG. 7(a) illustrates an example wire trap 200 in which the channel 201 comprises a flared opening the longitudinal ends of the channel 201. Other examples may have a flared opening at only one end of the channel 201. Such openings may facilitate introduction of a wire 300 into the wire trap 200.

FIG. 7(b) illustrates an example in which the wire trap 200 forms a bend. In general, a wire trap 200 may be formed to have any number of bends, as desired for the particular application the wire 300 is being used for.

FIG. 7(c) illustrates an alternative example of the wire trap 200 of FIG. 7(b), comprising a bend. In this case, only one of the channel walls 203 extends the full length of the wire trap 200, including the bend. The channel wall that extends the full length is the channel wall on the inside of the bend in the wire trap 200. The other channel wall 202 is formed of two parts, 202a, and 202b, located at the beginning and end of the bend respectively. The wire 300 is pulled towards the remaining wall 203 in the bend, so is retained without the need for the outside wall 202. This reduces the material needed to form the wire trap 200, and reduces the weight of the wire trap 200.

Some examples of the methods described above may comprise forming a plurality of wire traps. A plurality of wire traps 200 may be for holding a single wire 300. For example multiple small wire traps 200 may be placed along the intended path of the wire 300, rather than forming a single continuous wire trap 200. Alternatively or additionally, a plurality of wire traps 200 may be for holding a plurality of wires 300.

FIG. 8(a)-(c) illustrates examples comprising a plurality of wire traps 200. In FIG. 8 (a), a plurality of wire traps 200 are provided for retaining a single wire 300. Although three wire traps 200 are illustrated, any number of wire traps 200 may be used. Further, although the illustrated wire traps 200 are formed only on the straight parts of the example path of the wire 300, in other examples wire traps 200 may be positioned to hold the wire 300 during bends, as discussed above.

FIG. 8(b) illustrates a plurality of wire traps 200-1, 200-2, 200-3 for holding respective wires 300-1, 300-2, 300-3. Other examples may be formed for different numbers of wires. In this example, the wire traps 200-1, 200-2, 200-3 are immediately adjacent to each other, and follow the same wire path (i.e. a race track pattern). A single channel wall may be shared between adjacent wire traps 200, reducing the materials used and weight of the combined traps 200.

FIG. 8(c) illustrates an alternative example for retaining a plurality of wires 300. In this example, a subsequent wire trap 200-2 is formed on top of an existing wire trap 200-1. Any number of wire traps may be stacked in this way. For example in the illustrated example wire trap 200-3 is formed on top of wire trap 200-2. Wire trap 200-4 is formed on top of wire trap 200-3. As illustrated, such examples may enclose the respective channel 201 of each wire trap 200 as discussed above, for example using an additional layer of filaments to enclose the channel 201.

In examples where multiple wire traps 200 are formed for holding multiple wires 300, one or more of the wire traps 200 may be coloured to aid identification. For example, a colouring may be added to material forming one of the wire traps 200, and a different colouring may be added to the material forming a different one of the wire traps 200.

Any of the example methods discussed above may be performed by a robotic tool/apparatus for functionalising a product. In particular the robotic tool may comprise a deposition module configured to progressively deposit filaments onto a surface of a product to be functionalised, and a spatial manipulation system configured to allow relative movement between the product and at least a portion of the deposition module.

FIG. 9 illustrates an example of a robotic apparatus 400 performing the methods discussed herein. The apparatus 400 comprises a deposition module 402. The deposition module 402 progressively deposits filaments to form a structure comprising at least one layer. The progressive deposition of material may comprise an additive manufacturing process. The apparatus 400 comprises a spatial manipulation system configured to allow relative movement between a holder 408 for holding a product 101 onto which a wire trap 200 is to be formed. The relative movement includes translation relative to three mutually non-parallel (e.g. orthogonal) translation axes and rotation about two mutually non-parallel (e.g. orthogonal) rotation axes during either or both of the progressive deposition of material and the deposition of the one or more functional elements. The spatial manipulation system may comprise a first subsystem configured to provide the translation relative to the three mutually non-parallel translation axes and rotation about the two mutually non-parallel rotation axes, and a second subsystem configured to provide relative translational movement between the first subsystem and the structure being formed.

In the illustrated example, the deposition module 402 is mounted on an arm 404 which is connected to an x-y translation stage 406. The x-y translation stage 406 allows the arm 404, and thus the deposition module 402 attached thereto, to be moved in an x direction and in a y-direction, thereby providing two orthogonal translation axes.

The holder 408, which supports the product 101 as the wire trap 200 is being formed, is arranged on a first rotational stage 410 which is operatively connected to a z-height, i.e. vertical height, translation stage 412. The z-height translation stage 412 allows the holder 408 to be moved vertically up and down in the z-direction, thereby providing a third orthogonal translation axis.

The first rotational stage 410 is configured to allow the holder 408 to rotate relative to the deposition module 402. In the embodiment depicted, the first rotational stage 410 permits rotation in a plane orthogonal to the z-axis and parallel to the x and y axis.

A second rotational stage 424 is arranged between the deposition module 402 and the arm 404. The second rotational stage 424 allows rotation of the deposition module 402 in a plane parallel to the z-axis and orthogonal to the x and y axis. The second rotational stage 424 therefore permits rotation of the deposition module 402 relative to the holder 408.

In some examples, the apparatus 400 may further comprise a wire placing module, configured to position a wire 300 into a formed trap 200. Thus the apparatus 400 may be able to automatically functionalize a product 110 by forming one or more wire traps 200, and positioning a wire 300 into the traps.

1. A method of forming a wire trap on a surface of a product for holding a wire, the method comprising:
forming a wire trap by deposition onto the surface of the product such that the wire trap defines a channel for holding the wire, wherein the channel comprises a channel opening and channel walls defining a channel width that varies as a function of channel depth from the channel opening to a channel base of the channel, the channel opening having an opening width that is smaller than a maximum channel width such that, when received in the wire trap, a wire having a diameter larger than the opening width can be held in the channel by an interference fit.

2. The method of claim 1, wherein the wire trap is such that when the wire is received in the channel, the channel width above a widest part of the wire is less than a width of the widest part of the wire.

3. The method of claim 1, wherein the channel walls are formed by depositing a plurality of layers of material onto the surface of the product.

4. (canceled)

5. The method of claim 3, wherein forming the wire trap comprises depositing, using a fused filament fabrication technique, a plurality of layers of filaments on the surface of the product to form the wire trap.

6. The method of claim 5, wherein the channel opening is formed by a minimum spacing between opposing filaments of an upper layer of filaments.

7. The method of claim 5, wherein the plurality of layers consists of two layers of filaments.

8. The method of claim 5, wherein the plurality of layers of filaments are deposited such that corresponding filaments of contacting layers are aligned.

9. The method of claim 5, wherein the plurality of layers comprise at least three layers of filaments, wherein filaments of one or more middle layers of filaments are offset with respect to corresponding filaments of a lower layer of filaments and an upper layer of filaments to form the maximum channel width.

10. The method of claim 1, wherein the channel comprises a flared opening at one or both longitudinal ends of the channel.

11. The method of claim 2, comprising forming a plurality of wire traps for holding the same wire.

12. The method of claim 2, wherein forming the wire trap comprises forming the wire trap on an existing wire trap on the surface of the product.

13. The method of claim 1, further comprising depositing a polymer or adhesive into the channel for securing the wire when received in the channel.

14. (canceled)

15. The method of claim 1, wherein the method is an automated method performed by a robotic tool.

16. An automated method of positioning a wire on a surface of a product, the method comprising:
forming a wire trap on the surface of the product using the method of claim 1;
placing, using a robotic tool, a wire into the wire trap.

17. The method of claim 16, wherein both the forming of the wire trap and the placing of the wire into the wire trap are performed by the same robotic tool.

18. The method of claim 16, wherein placing the wire into the wire trap comprises applying a downwards force to press the wire into the wire trap.

19. A computer program comprising instructions which, when executed, cause the computer to perform the method of claim 1.

20. A computer readable medium storing the computer program of claim 19.

21. A robotic apparatus for functionalizing a product, the robotic apparatus comprising:
a deposition module configured to progressively deposit filaments onto a surface of a product to be functionalized; and
a spatial manipulation system configured to allow relative movement between the product and at least a portion of the deposition module;
wherein the robotic apparatus is configured to perform the method of claim 1.

22. A product comprising a wire trap for holding a wire, wherein the wire trap is formed by deposition onto a surface of the product, and defines a channel for holding the wire, wherein the channel comprises a channel opening and channel walls defining a channel width that varies as a function of channel depth from the channel opening to a channel base of the channel, the channel opening having an opening width that is smaller than a maximum channel width such that, when received in the wire trap, a wire having a diameter larger than the opening width can be held in the channel by an interference fit.
